(19) United States
(12) Patent Application Publication
(10) Pub. No.: US 2004/0005050 A1
(43) Pub. Date: Jan. 8, 2004

(54) Hands free personal phone holder

(76) Inventor: Wayne Lewis, Dalton, GA (US)

Correspondence Address: Martin L. McGregor, 26415 Oak Ridge Drive, Spring, TX, 77380, US

(21) Appl. No.: 10/189,049

(22) Filed: Jul. 2, 2002

(51) Int. Cl. H04M 1/00

(52) U.S. Cl. 379/455; 379/441

(57) ABSTRACT

The invention provides a holder to position a cellular telephone or other voice receiving and transmitting device near a shoulder of the wearer to permit hands free use of the cellular phone while in the field or the like.

### TECHNICAL FIELD

This invention relates to mounting devices for hands free operation of personal voice receiving and transmitting instruments such as cellular telephones and the like..

### BACKGROUND OF THE INVENTION

The prior discloses holders for mounting cellular or mobil phones in a vehicle compartment. U.S. Pat. Nos. 5,940,502; 6,097,810; and 6,215,870 to Hirai et al, each relates to a phone holder for mounting phones in a vehicle compartment. U.S. Pat. No. 6,108,197 to Janik discloses a wearable computing device includes computing-device component modules and flexible circuitry passing into the modules. The modules can include a top module portion and a bottom module portion, the flexible circuitry passing between the top and bottom portions. Wireless communication, e.g. by radio frequency, with a peripheral and/or a local area network is also contemplated. However the wearable computer wireless communication does include twp way communication by voice with the user. The present invention is a positioning harness for mounting a communications device voice input device near the users mouth while leaving the hands free.

### SUMMARY OF THE INVENTION

The present invention provides a holder for mounting a voice receiving and transmitting device near a shoulder of the wearer comprising a first vertical support member passing over the shoulder of the wearer, having a means for attaching a voice receiving device within the range of six to 18 inches of the mouth of the wearer, and a lateral member passing around the waist of the wearer and attached to the vertical support member. The lateral support member preferably includes means for releasing at least one end of the vertical means from engagement with the lateral support means. The harness may also include means for adjusting, the length of the first vertical support member. Preferably the relatable means is combined with the means that permits adjustment of the length of the vertical member. In an preferred embodiment a second lateral support means passes over the opposite shoulder of the wearer from the first vertical support, and is also adapted to receive means for attaching a voice receiving device within the range of six to 18 inches of the mouth of the wearer Preferably the harness also includes a means to adjust the length of the lateral member. A preferred embodiment also has a relatable means for attaching a voice receiving device. The preferred relatable means for attaching a voice receiving device is a hook and eye meshing means for releasably attaching a voice-receiving device. An especially preferred embodiment has at least one hook and eye meshing relatable means for securing the lateral member. The hook and eye fastener means may also Adjustably attach one or more vertical members to the lateral member A preferred hook and eye fastener material is manufacturer By Dupont under the trademark VELCRO®.

### BRIEF DESCRIPTION OF THE DRAWINGS

FIG. 1 shows a frontal view of a harness having two vertical members according to the invention.

### DETAILED DESCRIPTION OF THE INVENTION

With the cellular telephone becoming increasingly common, a need exists for a means to use the telephone in a hands free mode while engagedin other activities. The present invention may be used with any voice receiving and transmitting device, but the cellular telephone is the prefered instrument. The following description is for the best mode of practising the invention known to the invventor; and is provided to illustrate and not to limit the invention.

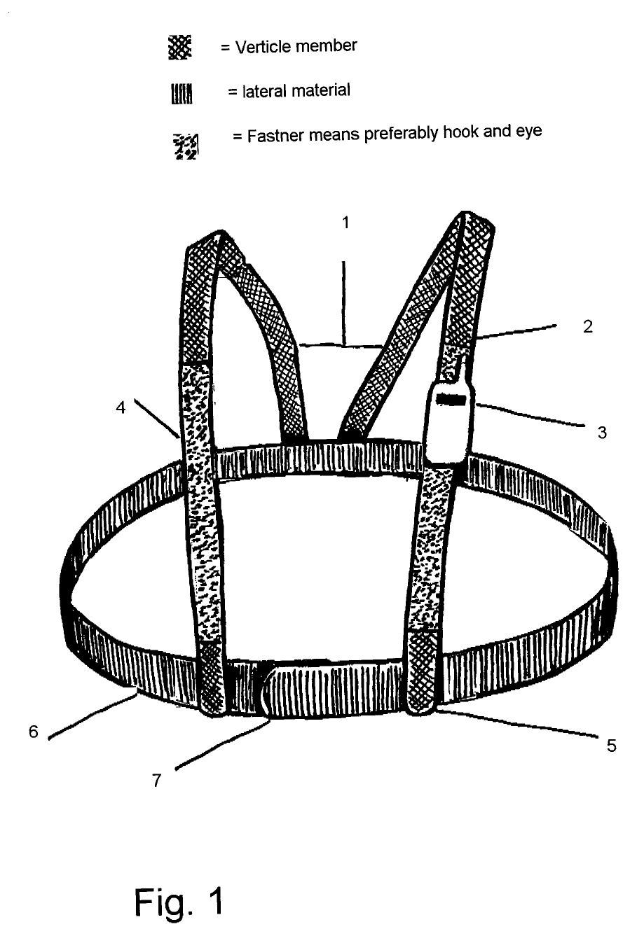

FIG. 1 illustrates a preferred embodiment of the invention 1 having two relatively vertical support members 2. The vertical support members can each support a voice receiving and transmitting communications device such as a cellular telephone, Citizens Band radio microphone and the like shown in FIG. 1 as reference number 3. The voice communications device is releasably attached to the vertical member 2 and preferably adjustably mounted to fall in the range of 6 to 18 inches from the mouth of the user. In an embodiment having two vertical members as illustrated either or both may include relatable mounting means for positioning a voice communications device as at numeral 4. A preferred relatable mounting means is a hook and eye fastener such as VELCRO®. The vertical support may be made from any flexible material but preferably will be of an open long lasting woven material such as nylon strapping. The vertical support members are preferably releasably attached to the lateral member with a releasable attachment 5, which may also permit adjustment of the length of the vertical member. The harness also includes a lateral member 6, preferably having a relatable closure means 7, which is preferably a hook and eye fastener means. The vertical member length adjustment may be permanently accomplished by trimming the vertical member to fit the wearer or temporarily by simply fixing it in a comfortable position and letting the end over lap the lateral member.

We claim:

1. A holder for mounting a voice receiving and transmitting device near a shoulder of the wearer comprising a first vertical support member passing over the shoulder of the wearer, having a means for attaching a voice receiving and transmitting device within auditory reception range of the mouth of the wearer, and a lateral member passing around the waist of the wearer and attached to the vertical support member.

2. A holder according to claim 1 wherein the lateral support member includes means for releasing at least one end of the vertical means from engagement with the lateral support means.

3. A holder according to claim 1, which includes means for adjusting, the length of the first vertical support member.

4. A holder according to claim 2 where the relatable means permits adjustment of the length of the vertical member.

5. A holder according to claim 1 having a second lateral support means passing over the opposite shoulder of the wear from the first vertical support, and adapted to receive means for attaching a voice receiving device within the range of six to 18 inches of the mouth of the wearer.

6. A holder according to claim 1 having a means to adjust the length of the lateral member.

7. A holder according to claim 1 having a relatable means for attaching a voice receiving device

8. A holder according to claim 1 having a hook and eye meshing means for releasably attaching a voice-receiving device.

9. A holder according to claim 1 having at least one hook and eye meshing releasable means for securing the lateral member.

10. A holder according to claim 1 having at least one hook and eye meshing releasable means for securing at least one vertical member to the lateral member.
